(19) United States
(12) Patent Application Publication
(10) Pub. No.: US 2014/0279282 A1
(43) Pub. Date: Sep. 18, 2014

(54) SYSTEM FOR CONDUCTING ELECTRONIC COMMERCE

(71) Applicant: Jonathan Begg, Washington Crossing, PA (US)

(72) Inventor: Jonathan Begg, Washington Crossing, PA (US)

(21) Appl. No.: 13/804,746

(22) Filed: Mar. 14, 2013

(51) Int. Cl. G06Q 30/06

(52) U.S. Cl. CPC G06Q 30/0641
USPC 705/27.1

(57) ABSTRACT

A computer system operated by a retailer, and optionally by an independent gift service provider, affords the intended recipient of a gift the opportunity to make a virtual gift exchange. Instead of physically receiving the gift, the recipient is enabled by the computer system to view a representation of the gift and to make various selections concerning the disposition of the gift, including exchange for credit, replacement by a product or products of equal, lesser, or greater value, or designation of a new recipient who then stands in the place of the originally designated recipient.

### FIELD OF THE INVENTION

This invention relates to electronic commerce, and more particularly to a system and process for facilitating the selection, purchase, delivery, and exchange, of a gift.

### BACKGROUND OF THE INVENTION

In today's robust e-commerce industry, a customer's ability to purchase a suitable gift for another individual, is subject to some inherent limitations. Simply ordering a gift on-line and having it shipped to an intended recipient can usually be carried out satisfactorily. However, there are instances in which the recipient is dissatisfied, and will want to return the gift or exchange it for something else. In the case of an item of apparel, for example, a wrong size, or an unsuitable color or pattern can be a reason for returning a gift. The recipient may already have the same item or a similar item.

Returning gift items, especially items shipped to a recipient by an on-line retailer, is difficult, time-consuming, and expensive.

There are also situations, apart from gift-giving occasions, in which an individual will wish to make a tentative selection of a product for possible purchase for his or her own use, but defer the final decision to make the purchase. For example, an individual when shopping for a set of bedroom sheets in a physical retail store, may find a set with which he or she is satisfied but wish to wait until her spouse, who is at home, concurs in the selection. There will also be occasions when the shopper in a physical retail store finds an item that he or she wishes to purchase, but is not sure whether or not the same item, or a suitable substitute, is already in his or her possession at home. In still other situations, the shopper will learn that the item is the last one of its kind currently in stock in the physical retail store.

A related problem is brought about in the case of “re-gifting,” i.e., passing a product received as a gift on to another person as a gift, either because the product duplicates something that the recipient already has or because the recipient, for another reason, does not want the product.

In conventional regifting, the cost of delivery of the product to the ultimate recipient through the intermediary of the intended recipient can, under some circumstances significantly exceed the cost of delivery of the product directly from a retailer to the ultimate recipient.

### SUMMARY OF THE INVENTION

To avoid the above-mentioned difficulties encountered in gift exchange, it is desirable for the recipient of a gift to be able to learn about the gift, and the details of the gift, before delivery. The recipient can then make a decision either to accept the gift as presented or to exchange the gift before it is shipped, thereby saving time and reducing costs.

In the case of a purchase of a product for the purchaser's own use, it will often be useful to conclude the purchase, but defer shipment until a final decision can be made.

In the cases of gift exchange, deferred purchasing decisions, and regifting, there is a need for improved efficiency and cost reduction, for the benefit not only of the purchaser, but also for the benefit of the retailer as well as for the benefit of the recipient.

Even with the many recent technological advances in online shopping, no one has been able to offer a comprehensive solution that addresses the aforementioned issues.

The invention addresses the above issues while enhancing the shopping experience both for the customer and for the retailer, and, in the case of a gift, the recipient as well.

The process begins with the purchaser's shopping, either online, or in person at a physical retail store such as a department store or a specialty store. The purchaser browses a retailer's website, or browses through goods on display in person at a retail store until a desired item is found. At this time, the purchaser proceeds to purchase the selected item using the retailer's checkout process. In the on-line checkout process the purchaser enters shipping information, and enters payment information (credit or debit card numbers, etc. or information to effect payment by a secure on-line fund transfer service). A similar process takes place when the purchaser visits the retailer in person, except that, in that situation, the purchaser usually provides shipping information to a store clerk for entry by the clerk, and either passes a credit or debit card through a card reader or allows the clerk to do so.

In accordance with the invention, during the checkout process, the purchaser can elect to place the purchased item into a virtual location where it is held for later retrieval either by the purchaser or by an intended recipient designated by the purchaser. Ideally, this virtual location will be a host website managed by an entity independent of the retailer. The independent entity can provide its host site service to each of multiple retailers.

In the case of a gift or an item intended for a recipient other than the purchaser, a gift service provider, operating the host website, issues a notification for delivery to the intended recipient. This notification can be in the form of an e-mail message to the intended recipient, or a card or similar paper notice for delivery to the intended recipient either by the customer in person or by regular mail or other suitable means of delivery. The message notifies the intended recipient that an item is being held for the benefit of the intended recipient and provides instructions for access to the item on the host site.

The intended recipient can then gain access to the host website using a link embedded in a notification e-mail message or by logging on to the host website using its web address, which will be included in the paper notice. The notification or web address will include a unique access code generated by the gift exchange service. Upon entry of appropriated retrieval information, the recipient is welcomed by a virtual presentation of the item being held for the recipient.

The virtual presentation can be in the form of a display of a picture of the item and can include descriptive information concerning the item as well as a message from the purchaser. In the case of a gift, the presentation can be in the form of a “virtual unwrapping,” in which a gift box is displayed on the recipient's computer screen, and unfolds to reveal the item inside. The message from the purchaser can be in the form of an electronic greeting card. The purchaser can be offered various options for the design and content of the greeting card, and can also be offered various options for the selection of colors and decorations on the virtual gift box or wrapping. For the recipient, the virtual unwrapping process and the electronic greeting card closely replicate the experience of receiving a gift in person.

Upon viewing the virtual representation of the gift, the recipient can accept the item as is, reject the item outright, cause the item to be sent to a different recipient (re-gifting), or exchange the item for one or more different items from the original retailer's site.

If the item is accepted as-is, the gift service provider prompts the retailer to initiate shipping to the end user, and confirms shipping information with end user. If the item is rejected outright by end user, the gift service provider prompts the retailer to issue a gift certificate to the recipient either via electronic delivery or by physical shipment. If the intended recipient decides the item is better suited for a different end user, he or she may send the item, virtually, to a new recipient. This selection will prompt the host-site to send a new notification e-mail to the new recipient, indicating that an item is present on the host-site servers awaiting retrieval, and the process is repeated.

If an intended recipient, whether he or she is the recipient designated by the original purchaser or a recipient designated by another intended recipient, elects to exchange the item, he or she has the ability to shop the original retailer's site for any item desired regardless of its price. The original item's price will be applied toward new item. If the new item's price is less than original item's price, end user can select additional items or elect to have a gift certificate issued for the remaining difference. If the new item's price is greater than original item's price, the recipient must pay the difference to retailer, and is prompted to enter payment information to complete the exchange. At the end of all possible selections by the end user, if an item is selected or exchanged, the gift service provider will prompt the retailer to ship the item to the end user, and if no item is selected or the item's price is less than original item's price, gift service provider will prompt the retailer to send a gift certificate via electronic or physical delivery.

The process allows both the customer and the recipient, if different parties, to have complete control of the item purchased for an indefinite amount of time. During this time, if the intended recipient notices any discrepancies concerning the original item's size, color, model, make, quantity, or personalization, or changes his or her mind about the item, he or she is afforded the ability to ensure utmost satisfaction with the purchase or gift.

More specifically, the invention is a system for conducting electronic commerce, which utilizes a computer system comprising at least one computer, although in an embodiment in which the gift service provider is an entity independent from the retailer, the computer system will normally comprise two computers, one operated by the retailer and the other operate by the gift service provider.

If the retailer is an on-line retailer, the computer system is programmed to generate a retail website and a gift service website. On the retail website, a variety of products is offered for sale, so that a customer, using a web browser, can select a product from the variety of products for purchase, enter an order for the selected product, and pay for the selected product, as in conventional on-line shopping. In this system, however, the retail website is linked electronically to the gift service website. The computer system is programmed to cause the customer to be offered, on the retail website, a choice among options including: (a) having a selected product shipped to a recipient address, and (b) having information concerning the selected product displayed to an intended recipient on the gift service website.

The computer system can also be programmed to enable the customer to enter a message to an intended recipient of the selected product, and to generate a representation of the message for delivery to the intended recipient. The computer system is programmed to allow the intended recipient to obtain electronic access to information concerning the selected product by display on the gift service website after the selected product has been paid for by the customer.

The computer system is also programmed to offer the intended recipient a choice from among the options of (c) accepting the product selected by the customer, (d) selecting a product offered by the retail website of equal or lesser value than that of the product selected by the customer, and (e) selecting a product offered by the retail website of greater value than that of the product selected by the customer. Thus, a product to be shipped to the recipient is the product selected by the customer or a product selected by the intended recipient. The product selected by the intended recipient can, of course, have a value equal to the value of the product selected by the customer.

The computer system is also programmed to issue a credit to the intended recipient when the product chosen by the intended recipient is of lesser value than that of the product selected by the customer; to receive a payment electronically from the intended recipient when the product chosen by the intended recipient is of greater value than that of the product selected by the customer; to allow the intended recipient to enter a designated shipping address; and to supply the retailer with the designated shipping address and with the identity of the product to be shipped. In this way, the retailer can cause the product to be shipped for delivery to the intended recipient.

The computer system also affords the intended recipient the opportunity to elect to re-gift, i.e., have the gift offered to another person as recipient. In that case, the newly designated recipient stands in the place of the originally designated recipient, and can be afforded some or all of the options that were available to the original designated recipient, including the ability to carry out a virtual exchange, and the ability to re-gift.

A principal advantage of the invention is that it enables a “virtual” gift exchange, thereby avoiding unnecessary shipping expenses while affording the recipient a high degree of flexibility in his or her choices. Another advantage of the invention is that it affords the customer the opportunity to send a gift “instantly,” i.e., to select a gift, purchase it, and notify the intended recipient that the gift has been purchased, within a very short time, e.g., a few minutes.

Further objects and advantages of the invention will be apparent from the following description when read in conjunction with the drawings.

### BRIEF DESCRIPTION OF THE DRAWINGS

FIG. 1 is a schematic block diagram illustrating the relationship between the principal elements of the electronic commerce system of the invention, and their relationship to the customer and the recipient;

FIG. 2 is a flow diagram of the portion of the process in which the customer communicates with the retailer; and

FIG. 3 is a flow diagram of the portion of the process in which the recipient communicates with the gift service provider.

### DETAILED DESCRIPTION OF THE PREFERRED EMBODIMENTS

The two principal elements of the electronic commerce system of the invention are a retailer and a gift service provider.

As shown in FIG. 1, block 10 represents a computer operated by a retailer, which can be an on-line retail organization from which a customer can only make purchase by on-line access, or an organization that operates one or more physical retail stores, e.g., department stores, and offers both in-person shopping and on-line shopping. The retailer can also offer telephone shopping or mail-order services, although such services have now been, for the most part, superseded by on-line retailing. In any case, the retailer will maintain a warehouse 12 and a shipping facility 14.

Block 16 represents the computer of a gift service provider, which, in the preferred embodiment is an organization that serves plural subscribing retailers. The gift service provider's computer is linked to the provider's subscribing retailers by a public electronic communication network 18, for example the Internet, or by a private wide area communication network.

Alternatively, the retailer can operate its own private gift service provider, in which case, the link can be a public network, a private wide area network, a private local area network, or an internal link within the retailer's computer, depending on the requirements and preferences of the retailer.

A customer 20, i.e., an individual or group of individuals desiring to make a purchase, can make purchases from the retailer by on-line access to a website operated by the retailer, using a terminal 22, which can be any computer or device having a web browser, such as a desktop or laptop computer, a tablet computer, or a smart phone. The retailer's on-line shopping system operates in a manner similar to any conventional on-line shopping system. That is, the customer can log on to the retailer's website, view product offerings, select items for purchase, placing the items in a virtual “shopping cart,” purchase the selected items by a “check-out” process, paying for the same by credit card, debit card, or through an independent secure payment service, and have them shipped to a selected delivery address by the retailer's shipping facility 14.

Alternatively, if the retailer offers in-person shopping as well as on-line shopping, the customer 20 can visit the retailer's store, or one of plural stores operated by the retailer. Here, the customer, instead of carrying his or her purchases from the store, can elect to have one or more purchased items shipped to a selected delivery address.

The system of FIG. 1 differs from the conventional on-line shopping system primarily by providing the purchaser with the option to utilize the gift service provider to defer delivery of the purchased item or items, so that an intended recipient 24 can view the items by on-line access to the gift service provider 16, using a terminal 26, which, as in the case of the customer's terminal, can be a desktop or laptop computer, a tablet computer, a smart phone, or similar web-access device. The intended recipient can then elect to accept the gift and have it shipped to an address of the recipients own selection, or in effect exchange the gift without expending the time, money and effort required to return it to the retailer.

As mentioned above, the customer can be the recipient. That is, the customer can buy a product for his or her own use, and defer delivery until a final decision to have the item delivered can be made.

The process of purchasing and delivering a gift is composed of two phases, depicted respectively in FIGS. 2 and 3. In the first phase, the customer communicates with the retailer, and in the second phase, the recipient communicates directly with the gift service provider and indirectly, through the gift service provider, with the retailer.

As shown in FIG. 2, in step 28 the customer selects a gift and pays for the gift, following the conventional procedure utilized in an in-store purchase or in an on-line purchase. Before the transaction is completed, however, the customer is given the opportunity, at step 30, to elect to have the purchased item delivered directly, or to have delivery deferred and to utilize the gift service provider. If the customer elects direct delivery, and is shopping personally in the retail store, the process proceeds from block 32 to a choice at block 34, where the purchaser can elect either to carry the purchased item out of the store himself at step 35, or to have it delivered in step 38 to an address entered in step 36. If the purchase is made on-line instead of in the store, the process proceeds directly from block 32, through the address entry step 36, and to the delivery step 38. The address entered in step 36 can, of course, be the address of an intended recipient, or any other address designated by the purchaser including the purchasers own address.

If at step 30, the purchaser elects to defer delivery, the retailer's web server begins to communicate with the gift service provider. Here, the process proceeds to block 40, in which the customer is given the opportunity to select the manner in which the gift is announced to the intended recipient. In the embodiment illustrated in FIG. 2, the customer has two choices: an e-mailed announcement, in which case the customer enters the intended recipient's e-mail address at step 42, and enters text for the announcement at step 44, whereupon the e-mail message is dispatched to the recipient. The customer can be given the opportunity to write the announcement message entirely on his own or to choose the message, or portions thereof, from a set of stock messages maintained on the server of the gift service provider. The format of the e-mailed announcement, including graphics, and even animated graphics, can also be chosen by the customer from a set of stock graphics maintained on the server of the gift service provider.

The customer can select a conventional printed greeting card, e.g., a birthday card, as an alternative to an e-mailed gift announcement. If the customer selects a printed card at decision block 40, the process proceeds to decision block 46, in which the customer is given the opportunity to have the card printed, retrieve the card, and deliver it personally at step 48. Here, the gift service provider can cause the card to be printed and delivered to the customer at the retailer's location if the customer is shopping in person, or transmit the card to the customer via the retailer's website or by e-mail for printing by the customer. The card can also be printed and mailed to the customer at the customer's address.

As a third alternative, the customer can elect to have the announcement card printed and mailed to the recipient, in which case the customer enters the recipient's mailing address at step 50, and the gift service provider prints and mails the card to the entered address at step 52.

Regardless of which path is followed in the generation and delivery of the gift announcement, the process proceeds to step 54, in which a virtual representation of the gift is posted on the gift service provider's website for on-line access by the intended recipient.

As will be apparent, unless the customer is also the recipient, the customer and the recipient have access to the system of the invention through two entirely different processes. The customer has access, through the retailer's website, to the process depicted in FIG. 2, whereas the intended recipient has access, through the gift service provider's website, to the process depicted in FIG. 3.

In FIG. 3, in step 56, the recipient is notified, typically by an e-mail message, or by a mailed or hand-delivered card, that he or she is to receive a gift. The notification message includes a link to, or the address of, a web page on which the virtual representation of the gift was posted in the process of FIG. 2. When the recipient logs onto this web page in step 58, the gift is displayed in step 60 from a database maintained by the gift service provider. Alternative methods of notification such as text messaging or computerized telephone calls can also be utilized.

The display step can take any of various forms. The display step can be as simple as the display of a still image of the gift. As an alternative, in the display step, an animated “virtual unwrapping” can take place. In a typical virtual unwrapping, a wrapped gift container is first displayed in a wrapping that can be selected by the purchaser in the part of the process of FIG. 2 that leads to the posting step 54. In the animation, the wrapping is gradually removed, and the container (if there is one) is opened to reveal the gift. In the part of the process of FIG. 2 leading to posting step 54, The customer can also be given an opportunity to enter a message that is displayed to the recipient before, during, or after, the virtual unwrapping.

As mentioned previously, one of the advantages of the system is that it affords the recipient the opportunity to “exchange” the gift without having personally received it. Thus it is unnecessary for the recipient to travel to the retail establishment to return the gift or to send it back to the retailer by mail or private courier. Not only does the recipient save time and money, but the retailer, by utilizing the gift service provider, can increase its profits significantly by reducing its number of shipments thereby reducing its shipping costs and also potentially reducing the number of personnel needed to process returns.

The recipient can, of course, decide at step 62 simply to accept the gift as presented, in which case the gift service provider requests entry of a shipping address by the recipient at step 64. The gift service provider then automatically notifies the retailer, in step 66, that the gift is to be shipped to the shipping address as entered, and the retailer ships the gift in step 68, just as it would in the case of a simple on-line order in which the gift service provider is not involved.

On the other hand, the recipient can decide at step 62 not to accept the gift as presented, and in that case, the recipient can be given several options: (a) receiving a gift card in lieu of the gift as presented, the gift card having a value equivalent to the sale price of the gift; (b) shopping at the retailer's website for another product of lesser value and receiving a gift card representing the price difference; or (c) shopping at the retailer's website for another product of greater value, and paying the difference.

Referring again to FIG. 3, if the recipient decides not to accept the gift as presented in step 60, then, at step 70, the gift service provider offers the recipient the option to receive a gift certificate having a value equivalent to that of the retail price of the gift. If the recipient exercises this option, at step 72, the gift service provider generates a gift certificate which the recipient can print and redeem at the retailer at a later time. In an alternative embodiment, the gift service provider can mail a gift card to the recipient after having the recipient enter a mailing address on line.

If the recipient decides to exchange the gift rather than receive a gift certificate or gift card having a value equivalent to that of the gift presented in step 60, the process proceeds to step 74, in which the gift service links the recipient to the retailer's website and obtains the recipient's preferred delivery address in step 76. After entry of the delivery address, the recipient can then shop, in step 78, for an alternative product or set of products among all of the products offered by the retailer.

Upon selection of the alternative product or set of products, at step 80, the gift service provider computer determines the difference between the retail price of the gift as presented in step 60, and the alternative selection.

If the price of the alternative selection is lower than that of the gift, the gift service provider, in step 82, generates a gift certificate having a value equivalent to the difference, and enables the recipient to print the gift certificate for later redemption. Alternatively, the gift certificate can be a virtual gift certificate held by the gift service provider in its database for later use by the recipient. In step 82, the gift service provider also notifies the retailer of the recipient's alternative selection, and the recipients shipping address, whereupon the retailer ships the alternative selection to the recipient in step 84. As an alternative to the electronically transmitted gift certificate, a gift card can be mailed to the recipient's delivery address, or included in the shipment of the alternative product selection.

If the price of the alternative selection is higher than that of the gift, the gift service provider causes the price difference to be displayed to the recipient in step 86, and gives the recipient the opportunity to pay the difference using the recipient's credit or debit card, or by using an independent secure payment service. Upon payment of the difference by the recipient in step 88, the gift service notifies the retailer, and the retailer then ships the alternative selection in step 99. The payment of the excess amount can be made to the retailer either directly, or to the gift service provider. In the latter case, the gift service provider will then credit the retailer with an amount of money corresponding to the difference between the price of the alternative selection and the price of the gift. A commission for the gift service provider can be built into the process in this step as well as in other steps of the process. Adjustments for differences in the shipping cost of the original selection and the shipping cost of the alternative selection can also be made.

An amount to cover shipping can be included in the amount paid by the purchaser upon purchase of the gift in step 28. Alternatively, when paying for the gift, the purchaser can authorize an amount to cover shipping, placing a limit on the shipping cost. If the recipient modifies the shipping method so that the shipping cost plus the price of the gift exceeds the amount paid or authorized by the purchaser, the recipient can be required to pay the difference as in the case where the recipient makes an alternative selection having a price higher than that of the gift initially selected by the customer.

As shown in FIG. 3, at step 70, the recipient, in addition to the options of taking a gift certificate or exchanging the gift, can be offered a “regift” option in which the original intended recipient has the opportunity to designate another recipient. The process reverts to step 30 in FIG. 2, and the original intended recipient is placed in the position of the original customer, and a new recipient is placed in the position of the original intended recipient. The original recipient can decide who the new recipient is to be, and decide how to notify the new recipient at step 40, and enter a new message intended for the new recipient. The gift is displayed at step 54, and the process proceeds as described previously, with the new recipient standing in place of the previously designated recipient, and having the same options that were available to the previously designated recipient.

A regifting recipient can also be afforded the opportunity to have gift certificate, with a value corresponding to the original purchase, to a newly designated recipient.

If the gift service provider is independent of the retailer, the compensation received by the gift service provider for its services can be determined in any of a number of ways. For example, the gift service provider can charge the retailer an agreed upon flat fee, or a fee based on the number of items of merchandise processed by the gift service provider in a predetermined interval of time, e.g., the number of items processed in each month or in each year. Alternatively the gift service provider can assess a fee based on the price of each item of merchandise processed by the gift service provider. The relationship between the assessed fee and the price of merchandise processed by the gift service provider does not need to be a linear relationship. The total assessed fee can be adjusted depending on the volume of merchandise processed by the gift service provider.

What is claimed is:

1. A system for conducting electronic commerce comprising:
a computer system programmed to generate a gift service website, said computer system being accessible by a retailer offering a variety of products for sale, and allowing the retailer, when a customer orders and pays for a selected product, to cause information concerning the selected product to be displayed on the gift service website to an intended recipient;
wherein said computer system is programmed to allow the intended recipient to obtain electronic access to said information concerning the selected product;
wherein said computer system is programmed to offer the intended recipient a choice from among the options of (c) accepting the product selected by the customer, (d) selecting a product offered by the retail website of equal or lesser value than that of the product selected by the customer, and (e) selecting a product offered by the retail website of greater value than that of the product selected by the customer, whereby a product to be shipped to the recipient is the product selected by the customer or a product selected by the intended recipient;
wherein said computer system is programmed to issue a credit to the intended recipient when the product chosen by the intended recipient is of lesser value than that of the product selected by the customer;
wherein said computer system is programmed to receive a payment electronically from the intended recipient when the product chosen by the intended recipient is of greater value than that of the product selected by the customer;
wherein said computer system is programmed to allow the intended recipient to enter a designated shipping address; and
wherein said computer system is programmed to supply the retailer with said designated shipping address and with the identity of the product to be shipped, whereby the retailer can cause said product to be shipped to be delivered to the intended recipient.

2. The system according to claim 1, wherein said computer system is also programmed to enable said customer to enter a message to an intended recipient of the selected product, and to generate a representation of said message for delivery to said intended recipient.

3. The system according to claim 1, wherein:
said computer system comprises a first computer programmed to generate said retail website and a second computer programmed to generate said gift service website;
said first computer is programmed to cause said customer to be offered, on said retail website, a choice among options including: (a) having a selected product shipped to a recipient address, and (b) having information concerning the selected product displayed on the gift service website to an intended recipient;
said second computer is programmed to allow the intended recipient to obtain electronic access to information concerning the selected product by display on the gift service website after the selected product has been paid for by the customer;
wherein said second computer is programmed to offer the intended recipient a choice from among the options of (c) accepting the product selected by the customer, (d) selecting a product offered by the retail website of equal or lesser value than that of the product selected by the customer, and (e) selecting a product offered by the retail website of greater value than that of the product selected by the customer, whereby a product to be shipped to the recipient is the product selected by the customer or a product selected by the intended recipient;
wherein said second computer is programmed to issue a credit to the intended recipient when the product chosen by the intended recipient is of lesser value than that of the product selected by the customer;
wherein said second computer is programmed to receive a payment electronically from the intended recipient when the product chosen by the intended recipient is of greater value than that of the product selected by the customer;
wherein said second computer is programmed to allow the intended recipient to enter a designated shipping address; and
wherein said second computer is programmed to supply the retailer with said designated shipping address and with the identity of the product to be shipped, whereby the retailer can cause said product to be shipped to be delivered to the intended recipient.

4. The system according to claim 3, wherein said first computer is also programmed to enable said customer to enter a message to an intended recipient of the selected product, and to generate a representation of said message for delivery to said intended recipient.

5. The system according to claim 1, wherein:
said computer system is also programmed to enable the intended recipient of the selected product to enter a second message to a second recipient, and to generate a representation of said second message to said second recipient; to enable the second recipient to enter a designated shipping address, and to supply the retailer with the shipping address designated by the second recipient;
wherein said computer system is also programmed to allow the second recipient to obtain electronic access to said information concerning the selected product; and
wherein said computer system is also programmed to offer the second recipient a choice from among the options of (c) accepting the product selected by the customer, (d) selecting a product offered by the retail website of equal or lesser value than that of the product selected by the customer, and (e) selecting a product offered by the retail website of greater value than that of the product selected by the customer, whereby a product to be shipped to the second recipient is the product selected by the customer or a product selected by the second recipient;
wherein said computer system is programmed to issue a credit to the second recipient when the product chosen by the second recipient is of lesser value than that of the product selected by the customer;
wherein said computer system is programmed to receive a payment electronically from the second recipient when the product chosen by the second recipient is of greater value than that of the product selected by the customer;
wherein said computer system is programmed to allow the second recipient to enter a designated shipping address; and
wherein said computer system is programmed to supply the retailer with the designated shipping address entered by the second recipient and with the identity of the product to be shipped, whereby the retailer can cause said product to be shipped to be delivered to the second recipient.

6. A system for conducting electronic commerce comprising:
a computer system comprising at least one computer, said computer system being programmed to generate a retail website and a gift service website;
wherein, on the retail website a variety of products is offered for sale, and a customer, using a web browser, can select a product from said variety of products for purchase, enter an order for the selected product, and pay for the selected product;
wherein said retail website is linked to said gift service website;
wherein said computer system is programmed to cause said customer to be offered, on said retail website, a choice among options including: (a) having a selected product shipped to a recipient address, and (b) having information concerning the selected product displayed on the gift service website to an intended recipient;
wherein said computer system is programmed to allow the intended recipient to obtain electronic access to information concerning the selected product by display on the gift service website after the selected product has been paid for by the customer;
wherein said computer system is programmed to offer the intended recipient a choice from among the options of (c) accepting the product selected by the customer, (d) selecting a product offered by the retail website of equal or lesser value than that of the product selected by the customer, and (e) selecting a product offered by the retail website of greater value than that of the product selected by the customer, whereby a product to be shipped to the recipient is the product selected by the customer or a product selected by the intended recipient;
wherein said computer system is programmed to issue a credit to the intended recipient when the product chosen by the intended recipient is of lesser value than that of the product selected by the customer;
wherein said computer system is programmed to receive a payment electronically from the intended recipient when the product chosen by the intended recipient is of greater value than that of the product selected by the customer;
wherein said computer system is programmed to allow the intended recipient to enter a designated shipping address; and
wherein said computer system is programmed to supply the retailer with said designated shipping address and with the identity of the product to be shipped, whereby the retailer can cause said product to be shipped to be delivered to the intended recipient.
